(19) United States
(12) Patent Application Publication
(10) Pub. No.: US 2014/0211858 A1
(43) Pub. Date: Jul. 31, 2014

(54) SPATIALLY ADAPTIVE VIDEO CODING

(71) Applicant: MICROSOFT CORPORATION, (US)

(72) Inventors: David Zhao, Solna (SE); Sergey Nikiforov, Stockholm (SE); Konrad Hofbauer, Stockholm (SE); Magnus Hemmendorff, Bromma (SE); Pontus Carlsson, Bromma (SE)

(73) Assignee: MICROSOFT CORPORATION, Redmond, WA (US)

(21) Appl. No.: 13/804,038

(22) Filed: Mar. 14, 2013

(30) Foreign Application Priority Data
Jan. 28, 2013 (GB) 1301442.8

(51) Int. Cl. H04N 19/85

(52) U.S. Cl. CPC H04N 19/00903
USPC 375/240.26

(57) ABSTRACT

A video signal comprises a sequence of source frames to be encoded. A pre-processing stage determines a region of interest for a plurality of the source frames, and spatially adapts each of the plurality of the source frames to produce a respective warped frame. In the respective warped frame, the region of interest comprises a higher spatial proportion of the warped frame than in the source frame. The pre-processing stage supplies the warped frames to an encoder to be encoded into an encoded version of the video signal.

### RELATED APPLICATION

This application claims priority under 35 USC 119 or 365 to Great Britain Application No. 1301442.8 filed Jan. 28, 2013, the disclosure of which is incorporate in its entirety.

### BACKGROUND

In modern communications systems a video signal may be sent from one terminal to another over a medium such as a wired and/or wireless network, often a packet-based network such as the Internet. For instanced the video may form part of a live video call such as a VoIP call (Voice over Internet Protocol).

Typically the frames of the video are encoded by an encoder at the transmitting terminal in order to compress them for transmission over the network. The encoding for a given frame may comprise intra frame encoding whereby blocks are encoded relative to other blocks in the same frame. In this case a block is encoded in terms of a difference (the residual) between that block and a neighbouring block. Alternatively the encoding for some frames may comprise inter frame encoding whereby blocks in the target frame are encoded relative to corresponding portions in a preceding frame, typically based on motion prediction. In this case a block is encoded in terms of a motion vector identifying an offset between the block and the corresponding portion from which it is to be predicted, and a difference (the residual) between the block and the corresponding portion from which it is predicted. A corresponding decoder at the receiver decodes the frames of the received video signal based on the appropriate type of prediction, in order to decompress them for output to a screen.

Although the encoding compresses the video, it can still incur a non-negligible cost in terms of bitrate, depending on the size of the encoded frames. If a frame is encoded with a relatively small number of pixels, i.e. at a low resolution, then some detail may be lost. If on the other hand a frame is encoded with a relatively large number of pixels, i.e. at a high resolution, then more detail is preserved but at the expense of a higher bitrate in the encoded signal. If the channel conditions will not support that bitrate, this could incur other distortions e.g. due to packet loss or delay.

### SUMMARY

A frame may contain regions with different sensitivity to resolution, e.g. facial features in the foreground with the background being less important. If the frame is encoded with a relatively high resolution, detail in the foreground may be preserved but bits will also be spent encoding unwanted detail in the background. On the other hand, if the frame is encoded with a relatively low resolution, then although bitrate will be saved, detail may be lost from the foreground.

In the following, prior to being input into the encoder, a frame is warped in space to give a region of interest a distortedly larger size relative to the other regions of the frame. This way, when the frame is then encoded, a higher proportion of the “bit budget” can be spent encoding detail in the foreground relative to the background (or more generally whatever region is of interest relative to one or more other regions). An inverse of the warping operation is then applied at the decoder side to recover a version of the original frame with the desired proportions for viewing.

In one aspect of the disclosure herein, there may be provided an apparatus or computer program for encoding a video signal comprising a sequence of source frames. The apparatus comprises an encoder and a pre-processing stage. The pre-processing stage is configured to determine a region of interest for a plurality of the source frames, and to spatially adapt each of the plurality of the source frames to produce a respective warped frame. In the respective warped frame, the region of interest comprises a higher spatial proportion of the warped frame than in the source frame. The pre-processing stage is arranged is to supply the warped frames to the encoder to be encoded into an encoded version of the video signal

In another aspect, there may be provided an apparatus or computer program for use in decoding the encoded video signal, configured with a post processing stage to reverse such spatial adaptation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any disadvantages noted herein.

### BRIEF DESCRIPTION OF THE DRAWINGS

FIG. 1 is a schematic representation of a video stream,

FIG. 2 is a schematic block diagram of a communication system,

FIG. 3 is a schematic representation of an encoded video stream,

FIG. 4 is a schematic block diagram of an encoder,

FIG. 5 is a schematic block diagram of a decoder, and

FIG. 6 is a schematic illustration of a spatial warping algorithm.

### DETAILED DESCRIPTION

At low bitrate it may be beneficial to reduce video resolution to reduce distortion introduced by coding. Frames may contain objects with different resolution sensitivity, e.g. a face in the foreground and a less important background. When decreasing resolution, important details in the face and communication cues may be lost. As such it may be beneficial to give a higher resolution to the face compared to the background.

One option could be to transmit two separate streams with different resolution. This may be complex in terms of implementation, and may not be very efficient.

According to embodiments of the disclosure herein, a solution is to “warp” the video frames at the sender side such that a face or other region of interest (ROI) is stretched out while the background is condensed. In embodiments, the output may be a rectangular frame suitable for coding with an existing encoder standard such as H.264. The warped frame may be the same overall resolution as the source frame, but with a higher proportion used to represent the face or other ROI. Alternatively the whole frame may be scaled down, but with a lesser scaling applied to the face or ROI.

At the receiver side, the inverse warping is applied to reconstruct the source video.

An advantage which may thus be achieved is that the face is coded with higher resolution and communication cues are preserved better.

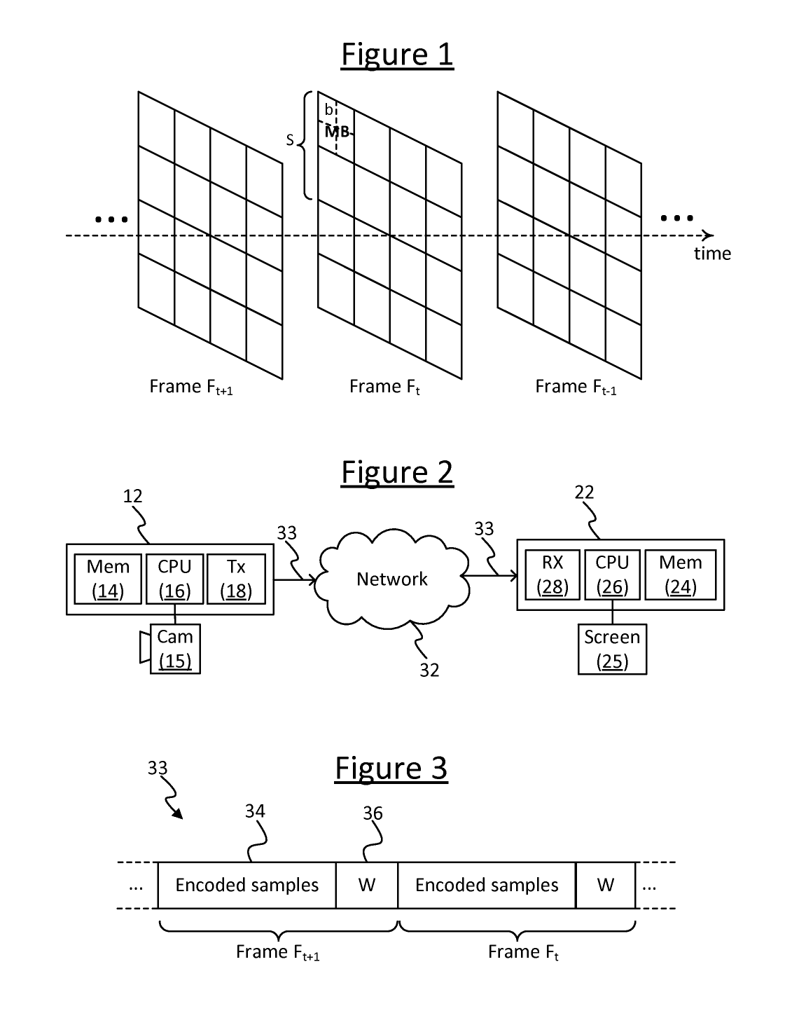

FIG. 1 gives a schematic illustration of a video signal captured from a camera, and divided into portions ready to be encoded by a video encoder so as to generate an encoded bitstream. The signal comprises a moving video image divided in time into plurality of frames (F), each frame representing the image at a different respective moment in time ( . . . t−1, t, t+1 . . . ). Within each frame, the frame is divided in space into a plurality of portions each representing a plurality of pixels. The portions may for example be referred to as blocks. In certain schemes, the frame is divided and sub-divided into different levels of portion or block. For example each frame may be divided into macroblocks (MB) and each macroblock may be divided into blocks (b), e.g. each block representing a region of 8×8 pixels within a frame and each macroblock representing a region of 2×2 blocks (16×16 pixels). In certain schemes each frame can also be divided into slices (S), each comprising a plurality of macroblocks.

A block in the video signal may initially be represented in the spatial domain, where each channel is represented as a function of spatial position within the block, e.g. each of the luminance (Y) and chrominance (U,V) channels being a function of Cartesian coordinates x and y, Y(x,y), U(x,y) and V(x,y). In this representation, each block or portion is represented by a set of pixel values at different spatial coordinates, e.g. x and y coordinates, so that each channel of the colour space is represented in terms of a particular value at a particular location within the block, another value at another location within the block, and so forth.

The block may however be transformed into a transform domain representation as part of the encoding process, typically a spatial frequency domain representation (sometimes just referred to as the frequency domain). In the frequency domain the block is represented in terms of a system of frequency components representing the variation in each colour space channel across the block, e.g. the variation in each of the luminance Y and the two chrominances U and V across the block. Mathematically speaking, in the frequency domain each of the channels (each of the luminance and two chrominance channels or such like) is represented as a function of spatial frequency, having the dimension of 1/length in a given direction. For example this could be denoted by wavenumbers kₓ and k_{y} in the horizontal and vertical directions respectively, so that the channels may be expressed as Y(kₓ, k_{y}), U(kₓ, k_{y}) and V(kₓ, k_{y}) respectively. The block is therefore transformed to a set of coefficients which may be considered to represent the amplitudes of different spatial frequency terms which make up the block. Possibilities for such transforms include the Discrete Cosine transform (DCT), Karhunen-LoeveTransform (KLT), or others.

An example communication system in which the various embodiments may be employed is illustrated schematically in the block diagram of FIG. 2. The communication system comprises a first, transmitting terminal 12 and a second, receiving terminal 22. For example, each terminal 12, 22 may comprise one of a mobile phone or smart phone, tablet, laptop computer, desktop computer, or other household appliance such as a television set, set-top box, stereo system, etc. The first and second terminals 12, 22 are each operatively coupled to a communication network 32 and the first, transmitting terminal 12 is thereby arranged to transmit signals which will be received by the second, receiving terminal 22. Of course the transmitting terminal 12 may also be capable of receiving signals from the receiving terminal 22 and vice versa, but for the purpose of discussion the transmission is described herein from the perspective of the first terminal 12 and the reception is described from the perspective of the second terminal 22. The communication network 32 may comprise for example a packet-based network such as a wide area internet and/or local area network, and/or a mobile cellular network.

The first terminal 12 comprises a computer-readable storage medium 14 such as a flash memory or other electronic memory, a magnetic storage device, and/or an optical storage device. The first terminal 12 also comprises a processing apparatus 16 in the form of a processor or CPU having one or more execution units; a transceiver such as a wired or wireless modem having at least a transmitter 18; and a video camera 15 which may or may not be housed within the same casing as the rest of the terminal 12. The storage medium 14, video camera 15 and transmitter 18 are each operatively coupled to the processing apparatus 16, and the transmitter 18 is operatively coupled to the network 32 via a wired or wireless link. Similarly, the second terminal 22 comprises a computer-readable storage medium 24 such as an electronic, magnetic, and/or an optical storage device; and a processing apparatus 26 in the form of a CPU having one or more execution units. The second terminal comprises a transceiver such as a wired or wireless modem having at least a receiver 28; and a screen 25 which may or may not be housed within the same casing as the rest of the terminal 22. The storage medium 24, screen 25 and receiver 28 of the second terminal are each operatively coupled to the respective processing apparatus 26, and the receiver 28 is operatively coupled to the network 32 via a wired or wireless link.

The storage 14 on the first terminal 12 stores at least a video encoder arranged to be executed on the processing apparatus 16. When executed the encoder receives a an unencoded video stream from the video camera 15, encodes the video stream so as to compress it into a lower bitrate stream, and outputs the encoded video stream for transmission via the transmitter 18 and communication network 32 to the receiver 28 of the second terminal 22. The storage 24 on the second terminal 22 stores at least a video decoder arranged to be executed on its own processing apparatus 26. When executed the decoder receives the encoded video stream from the receiver 28 and decodes it for output to the screen 25. A generic term that may be used to refer to an encoder and/or decoder is a codec.

FIG. 3 gives a schematic representation of an encoded bitstream 33 as would be transmitted from the encoder running on the transmitting terminal 12 to the decoder running on the receiving terminal 22. The bitstream 33 comprises a plurality of encoded samples 34 for each frame, including any motion vectors. In one application, the bitstream may be transmitted as part of a live (real-time) video phone call such as a VoIP call between the transmitting and receiving terminals 12, 22 (VoIP calls can also include video).

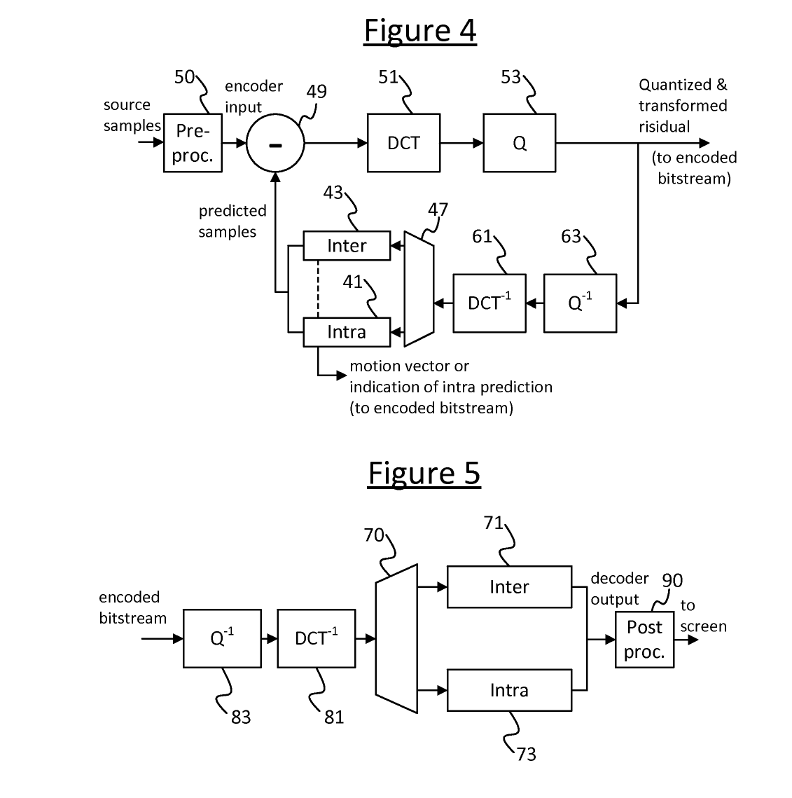

FIG. 4 is a high-level block diagram schematically illustrating an encoder-side system such as might be implemented on transmitting terminal 12. The system comprises an encoder, comprising: a discrete cosine transform (DCT) module 51, a quantizer 53, an inverse transform module 61, an inverse quantizer 63, an intra prediction module 41, an inter prediction module 43, a switch 47, and a subtraction stage (−) 49. The system also comprises a pre-processing stage 50 coupled to the input of the encoder. Each of these modules or stages may be implemented as a portion of code stored on the transmitting terminal's storage medium 14 and arranged for execution on its processing apparatus 16, though the possibility of some or all of these being wholly or partially implemented in dedicated hardware circuitry is not excluded.

The subtraction stage 49 is arranged to receive an instance of an input video signal comprising a plurality of blocks (b) over a plurality of frames (F). The input video stream is received from a camera 15 coupled to the input of the subtraction stage 49, via the pre-processing stage 50 coupled between the camera 15 and the input of the subtraction stage 49. As will be discussed in more detail below, the frames that are input to the encoder have already been warped by the pre-processing stage 50, to increase the size of a region of interest (ROI) relative to one or more other regions prior to encoding. The encoder (elements 41, 43, 47, 49, 51, 53, 61, 63) then continues to encode the warped input frames as if they were any other input signal—the encoder does not itself need to have any knowledge of the warping.

Accordingly, following the warping, the intra or inter prediction generates a predicted version of a current (target) block in the input signal to be encoded based on a prediction from another, already-encoded block or other such portion. The predicted version is supplied to an input of the subtraction stage 49, where it is subtracted from the input signal to produce a residual signal representing a difference between the predicted version of the block and the corresponding block in the input signal.

In intra prediction mode, the intra prediction 41 module generates a predicted version of the current (target) block to be encoded based on a prediction from another, already-encoded block in the same frame, typically based on a predetermined neighbouring block. When performing intra frame encoding, the idea is to only encode and transmit a measure of how a portion of image data within a frame differs from another portion within that same frame. That portion can then be predicted at the decoder (given some absolute data to begin with), and so it is only necessary to transmit the difference between the prediction and the actual data rather than the actual data itself. The difference signal is typically smaller in magnitude, so takes fewer bits to encode.

In inter prediction mode, the inter prediction module 43 generates a predicted version of the current (target) block to be encoded based on a prediction from another, already-encoded region in a different frame than the current block, offset by a motion vector predicted by the inter prediction module 43 (inter prediction may also be referred to as motion prediction). In this case, the inter prediction module 43 is switched into the feedback path by switch 47, in place of the intra frame prediction stage 41, and so a feedback loop is thus created between blocks of one frame and another in order to encode the inter frame relative to those of a preceding frame. This typically takes even fewer bits to encode than an intra frame.

The samples of the residual signal (comprising the residual blocks after the predictions are subtracted from the input signal) are output from the subtraction stage 49 through the transform (DCT) module 51 (or other suitable transformation) where their residual values are converted into the frequency domain, then to the quantizer 53 where the transformed values are converted to discrete quantization indices. The quantized, transformed indices 34 of the residual as generated by the transform and quantization modules 51, 53, as well as an indication of the prediction used in the prediction modules 41,43 and any motion vectors generated by the inter prediction module 43, are all output for inclusion in the encoded video stream 33 (see element 34 in FIG. 3); typically via a further, lossless encoding stage such as an entropy encoder (not shown) where the prediction values and transformed, quantized indices may be further compressed using lossless encoding techniques known in the art.

An instance of the quantized, transformed signal is also fed back though the inverse quantizer 63 and inverse transform module 61 to generate a predicted version of the block (as would be seen at the decoder) for use by the selected prediction module 41 or 43 in predicting a subsequent block to be encoded. Similarly, the current target block being encoded is predicted based on an inverse quantized and inverse transformed version of a previously encoded block. The switch 47 is arranged pass the output of the inverse quantizer 63 to the input of either the intra prediction module 41 or inter prediction module 43 as appropriate to the encoding used for the frame or block currently being encoded.

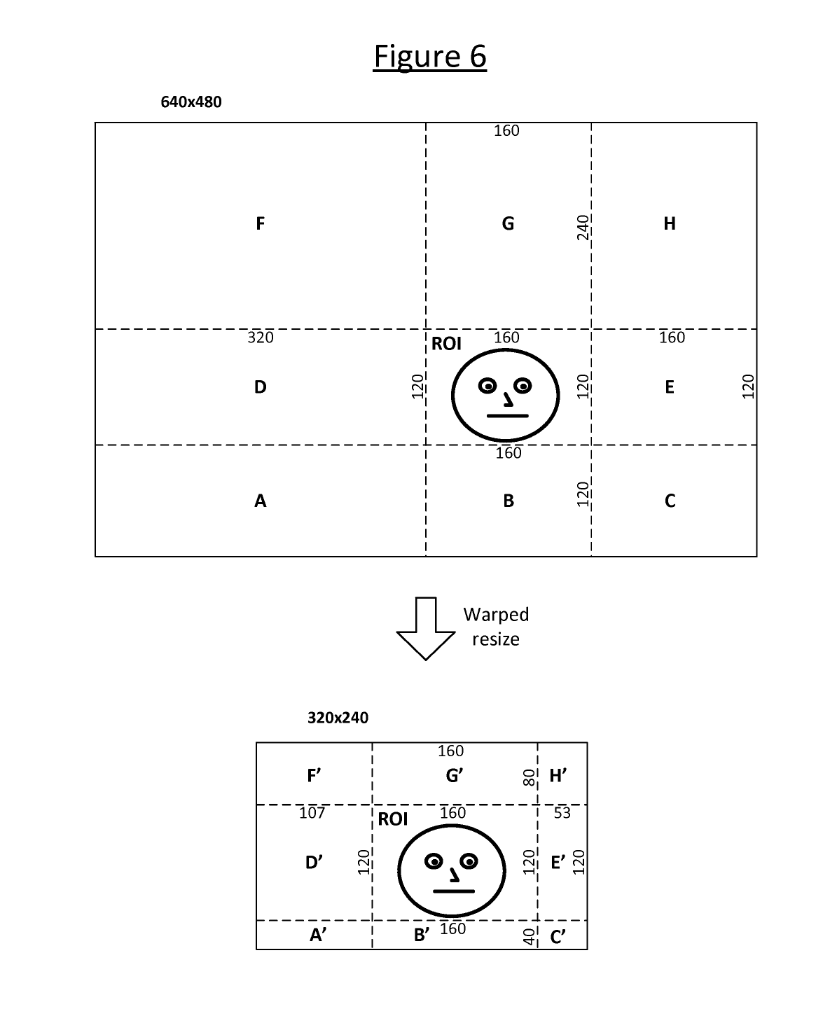

FIG. 5 is a high-level block diagram schematically illustrating a decoder-side system such as might be implemented on receiving terminal 22. The system comprises a decoder, comprising an inverse quantization stage 83, an inverse DCT transform stage 81, a switch 70, and an intra prediction stage 71 and a motion compensation stage 73. The system also comprises a post-processing stage 90 coupled to the output of the decoder. Each of these modules or stages may be implemented as a portion of code stored on the receiving terminal's storage medium 24 and arranged for execution on its processing apparatus 26, though the possibility of some or all of these being wholly or partially implemented in dedicated hardware circuitry is not excluded.

The inverse quantizer 81 is arranged to receive the encoded signal 33 from the encoder, via the receiver 28 (and via any lossless decoding stage such as an entropy decoder, not shown). The inverse quantizer 81 converts the quantization indices in the encoded signal into de-quantized samples of the residual signal (comprising the residual blocks) and passes the de-quantized samples to the reverse DCT module 81 where they are transformed back from the frequency domain to the spatial domain. The switch 70 then passes the de-quantized, spatial domain residual samples to the intra or inter prediction module 71 or 73 as appropriate to the prediction mode used for the current frame or block being decoded, where intra or inter prediction respectively is used to decode the blocks (using the indication of the prediction and/or any motion vectors received in the encoded bitstream 33 as appropriate). The output of the DCT module 51 (or other suitable transformation) is a transformed residual signal comprising a plurality of transformed blocks for each frame. The decoded blocks is output to the screen 25 at the receiving terminal 22 via the post-processing stage 90.

As mentioned, at the encoder side the frames of the video signal are warped by the pre-processing stage 50 prior to being input to the encoder. The un-warped source frames are those supplied from the camera 15 to the pre-processing stage 50, though note this does not necessarily preclude there having been some initial (uniform) reduction in resolution or initial quantization between the camera's image sensing element and the warping by the pre-processing stage 50—“source” as used herein does not necessarily limit to absolute source. It will be appreciated that modern cameras may typically capture image data at a higher resolution and/or colour depth than is needed (or indeed desirable) for transmission over a network, and hence some initial reduction of the image data may be have been applied before even the pre-processing stage 50 or encoder, to produce the source frames for supply to the pre-processing stage 50.

FIG. 6 gives a schematic illustration of an example of a resizing and warping operation that may be performed by the pre-processing module 50 in accordance with embodiments disclosed herein.

The top of FIG. 6 shows a source frame, e.g. a source VGA (video graphics adapter) image of resolution 640×480 pixels. The bottom of FIG. 6 shows a resized version of this same frame, e.g. of resolution 320×240 pixels (half the width and half the height), which is to be encoded and transmitted to the receiving terminal 22 over the network 32. In embodiments, both the source and the resized frames are rectangular, in the same ratio, making the resized frame suitable for passing through a conventional encoder such as an H.264 encoder. The reduction in resolution reduces the number of bits required to encode the frame in the bitstream 33, making it more suitable for transmission of a network 32, especially under poor conditions (e.g. congestion or high noise or interference).

However, a straightforward resizing from 640×480 to 320×240 may remove important details from a region of interest such as a face or facial region.

Therefore instead, the pre-processing module 50 may be configured to perform a “warped resize” operation to keep a better resolution in the face than in the rest of the frame. In the example, the resolution of the face is completely maintained (no scaling down), and the resolution of the background region is scaled down to fit what pixel allowance remains in the resized frame.

One example of warping function would be: X′=BilinearResize(X) where X is the source frame, X′ the scaled and warped frame, and BilinearResize represents a bilinear scaling function (a scaling that is linear in each of two dimensions) applied to the remaining region outside of the region of interest, to fit whatever pixel allowance or “pixel budget” remains in the scaled-down frame (whatever is not taken up by the region of interest). E.g. the bilinear scaling may be a bilinear interpolation.

For instance, in FIG. 6 the region of interest (ROI) is identified as a 160×120 pixel rectangular region in the source frame starting 320 pixels from the left hand side of the frame and 240 pixels from the top of the frame (continuing for 160×120 pixels in the left-to-right and top-to-bottom directions respectively). This leaves a remaining region in the source frame made up of sections A (320×120 pixels), B (160×120), C (160×120), D (320×120), E (160×120), F (320×240), G (160×240) and H (160×24). Thus the background gets a total of 320+160=480 pixels in the horizontal direction and 240+120=360 pixels in the vertical direction.

In the example shown, the region of interest (ROI) is not scaled down at all in the warped, resized version of the frame. I.e. it remains a 160×120 pixel rectangular region in the resized frame. This means the rest of the background region has to be “squashed up” to accommodate the region of interest which now claims a higher proportion of the resized frame than it did in the source frame. In the scaled down frame, the background regions corresponding to A, B, C, D, F, G and H are labelled A′, B′, C′, D′, E′, F′, G′ and H′ for reference.

In FIG. 6, this leaves the background with 320−160=160 pixels in the horizontal direction, which is 160/480=1/3 of what it had in the source frame. Thus each section A′, C′, D′, E′, F′ and G′ is scaled by 1/3 in the horizontal direction. In the vertical direction, the background is left with 240-120—120 pixels, which is 120/360=1/3 of what it had previously. Thus each section A′, B′, C′, F′, G′ and H′ is scaled by 1/3 in the vertical direction. Hence the new, scaled down pixel dimensions of the background region are: A′ (107×40), B′ (160×40), C′ (53×40), D′ (107×120), E′ (53×120), F′ (107×80), G′ (160×80) and H′ (80×53).

The same logic can be applied for other sized regions of interest. In alternative embodiments, the region of interest could be scaled down as well, but to a lesser degree than the background (i.e. not scaled down as much as the background). The background (any region outside) is scaled according to the remaining allowance given the size of the region of interest in the scaled-down frame. In other alternative embodiments, the frame as whole need not be scaled down, but rather the region of interest may be scaled up to make better use of the existing resolution at the expense of the other, background regions being scaled down. Further, while the above has been described in terms of a rectangular region of interest (square or oblong), in yet further embodiments the warping is not limited to any particular shape region of interest or linear scaling, and other warping algorithms may be applied.

Note that the above may produce discontinuities along borders, e.g. A′ and B′, because the horizontal resolution of A′ and B′ is different. However, the effect may be considered more tolerable than losing resolution (or too much resolution) in the region of interest, and more tolerable than incurring too high a bitrate in the encoded stream 33.

The region of interest is determined at the encoder side by any suitable means, e.g. by a facial recognition algorithm applied at the pre-processing module 50, or selected by the user, or being a predetermined region such as a certain region at the centre of the frame. The process may be repeated over a plurality of frames. Determining the region of interest for a plurality of frames may comprise identifying a respective region of interest individually in each frame, or identifying a region of interest once in one frame and then assuming the region of interest continues to apply for one or more subsequent frames.

In further embodiments, the pre-processing module 50 is configured to adapt the size of the frame to be encoded (as input to the encoder) in response to conditions on the network 32 or other transmission medium. For example, the pre-processing module 50 may be configured to receive one or more items of information relating to channel conditions fed back via a transceiver of the transmitting terminal 12, e.g. fed back from the receiving terminal. The information could indicate a round-trip delay, loss rate or error rate on the medium, or any other information relevant to one or more channel conditions. The pre-processing module 50 may then adapt the frame size depending on such information. For example, if the information indicates that the channel conditions are worse than a threshold it may select to use the scaled-down version of frames to be encoded, but if the channel conditions meet or exceed the threshold then the pre-processing module may select to send the source frames on to the encoder without scaling or warping.

In further embodiments, the pre-processing module 50 could be configured to be able to apply more than two different frame sizes, and to vary the frame size with the severity of the channel conditions. Alternatively a fixed scaling and warping could be applied, or the scaled-down frame size could be a user setting selected by the user.

The pre-processing module 50 may be configured to generate an indication 53 relating to the scaling and/or warping that has been applied. For example this may specify a warping map, or an indication of one or more predetermined warping processes known to both the encoder and decoder sides (e.g. referring to a warping “codebook”). Alternatively or additionally, the indication 53 may comprise information identifying the region of interest. The pre-processing module 50 may then supply this indication 53 to be included as an element in the encoded bitstream 33 transmitted to the receiving terminal 22, or sent separately over the network 32 or other network or medium. The post-processing module 90 on the receiving terminal 22 is thus able to determine the inverse of the warping and the inverse of any scaling that has been applied at the transmitting terminal 12.

Alternatively, both the pre-processing module 50 at the encoder side and the post-processing module 90 at the decoder side may be configured to use a single, fixed predetermined scaling and/or warping; or the same scaling and/or warping could be pre-selected by the respective users at the transmitting and receiving terminals 12, 22, e.g. having agreed what scheme to use beforehand. With regard to identifying the region of interest at the decoder side, the post-processing module 90 may determine this from the element 36 sent from the post-processing module 90 or may determine the region of interest separately at the decoder side, e.g. by applying a same facial recognition algorithm as the decoder side, or the region of interest having been selected to be the same by a user of the receiving terminal 22 (having pre-agreed this with the user of the transmitting terminal 12), or the post-processing module 90 having predetermined knowledge of a predetermined region of interest (such as a certain region at the centre of the frame which the pre-processing module 50 is also configured to use).

Either way, the warped frames (including any scaling of the frame as a whole) are passed through the encoder at the transmitting terminal 12 where the encoder (elements 41-49 and 51-63) treats them like any other frames. The encoder in itself can be a standard encoder than does not need to have any knowledge of the warping. Likewise at the receiving terminal, the decoder (elements 70-83) decodes the warped frames as if they were any other frames, and the decoder in itself can be a standard decoder without any knowledge of the warping or how to reverse it. For example the encoder and decoder may be implemented in accordance with standards like H.264 or H.265. When the decoded frames, still containing the warping, are passed to post-processing module 90 this is where the warping (and any scaling of the frame as a whole) is reversed, based on the post-processing module's a priori or a posteriori knowledge of the original warping operation.

It will be appreciated that the above embodiments have been described only by way of example.

While the above has been described in terms of blocks and macroblocks, the region of interest does not have to be mapped or defined in terms of the blocks or macroblocks of any particular standard. In embodiments the region of interest may be mapped or defined in terms of any portion or portions of the frame, even down to a pixel-by-pixel level, and the portions used to define the region of interest do not have to be same as the divisions used for other encoding/decoding operations such as prediction (though in embodiments they may well be).

Further, the applicability of the teaching here is not limited to an application in which the encoded video is transmitted over a network. For example in another application, receiving may also refer to receiving the video from a storage device such as an optical disk, hard drive or other magnetic storage, or “flash” memory stick or other electronic memory. In this case the video may be transferred by storing the video on the storage medium at the transmitting device, removing the storage medium and physically transporting it to be connected to the receiving device where it is retrieved. Alternatively the receiving device may have previously stored the video itself at local storage.

In embodiments, the indication of the warping, scaling and/or ROI does not have to be embedded in the transmitted bitstream. In other embodiments it could be sent separately over the network 32 or another network. Alternatively as discussed, in yet further embodiments some or all of this information may be determined independently at the decoder side, or predetermined at both encoder and decoder side.

The techniques disclosed herein can be implemented as an add-on to an existing standard such as an add-on to H.264 or H.265; or can be implemented as an intrinsic part of an encoder or decoder, e.g. incorporated as an update to an existing standard such as H.264 or H.265. Further, the scope of the disclosure is not restricted specifically to any particular representation of video samples whether in terms of RGB, YUV or otherwise. Nor is the scope limited to any particular quantization, nor to a DCT transform. E.g. an alternative transform such as a Karhunen-LoeveTransform (KLT) could be used, or no transform may be used. Further, the disclosure is not limited to VoIP communications or communications over any particular kind of network, but could be used in any network capable of communicating digital data, or in a system for storing encoded data on a storage medium.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors. For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations. One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. Apparatus for encoding a video signal comprising a sequence of source frames, the apparatus comprising:
an encoder; and
a pre-processing stage configured to determine a region of interest for a plurality of the source frames, and to spatially adapt each of the plurality of the source frames to produce a respective warped frame in which the region of interest comprises a higher spatial proportion of the warped frame than in the source frame;
wherein the pre-processing stage is arranged is to supply the warped frames to the encoder to be encoded into an encoded version of the video signal.

2. The apparatus of claim 1, wherein the warped frames have the same resolution as the source frames.

3. The apparatus of claim 1, wherein said spatial adaptation comprises resizing each of said plurality of source frames as well as being warped, each of the respective warped frames having lower resolution than the source frame.

4. The apparatus of claim 3, wherein the region of interest remains the same resolution in the warped frame as in the source frame, while the remaining regions are scaled down to a lower resolution to fit the warped frame.

5. The apparatus of claim 3 wherein the region of interest is scaled down to a lower resolution in the warped frame than in the source frame, while remaining regions are scaled down to an even lower resolution to fit the warped frame.

6. The apparatus of claim 1, wherein the region of interest is rectangular.

7. The apparatus of claim 1, wherein both the source frames and the warped frames are rectangular.

8. The apparatus of claim 7, wherein both the source frames and the warped frames have the same ratio of width to height.

9. The apparatus of claim 1, comprising a transmitter arranged to transmit the encoded video signal to a receiving terminal over a medium.

10. The apparatus of claim 9, wherein said medium comprises a packet-based network.

11. The apparatus if claim 9, wherein the encoded video signal comprises a live video stream transmitted as part of a live video call.

12. The apparatus of claim 9, wherein the transmitter is further arranged to transmit an indication regarding the spatial adaptation to the receiving terminal for use in reversing said spatial adaptation at the receiving terminal.

13. The apparatus of claim 9, wherein:
the region of interest is scaled down to a lower resolution in the warped frame than in the source frame, while remaining regions are scaled down to an even lower resolution to fit the warped frame; and
the pre-processing stage is configured to adapt the resizing in dependence on one or more conditions on said medium.

14. The apparatus of claim 1, wherein the region of interest comprises at least part of a face, and the pre-processing stage comprises a facial recognition algorithm configured to identify the region of interest based on one or more of the source frames.

15. The apparatus of claim 1, wherein the encoder is spatially uniform in its encoding, in that it does not adapt relative spatial proportions of regions within frames once input to the encoder.

16. The apparatus of claim 1, wherein the encoder is an H.264 or H.265 encoder.

17. Apparatus for decoding a video signal, the apparatus comprising:
a decoder arranged to decode the video signal to produce a plurality of warped frames, each having been spatially adapted from a respective source frame so that a region of interest comprises a higher spatial proportion of the warped frame than in the source frame; and
a post-processing stage configured to reverse said spatial adaptation to output decoded versions of the source frames.

18. The apparatus of claim 17, wherein the post-processing stage is configured to receive an indication regarding the spatial adaptation from a transmitting terminal, and to reverse the spatial adaptation based on said indication.

19. A computer program product for encoding a video signal comprising a sequence of source frames, the computer program product comprising code embodied on a computer-readable medium and configured to as when executed on a transmitting terminal to perform operations of:
determining a region of interest for a plurality of the source frames, the region of interest comprising at least part of a face of a user of the transmitting terminal;
applying pre-processing to spatially adapt each of the plurality of the source frames to produce a respective warped frame in which the region of interest comprises a higher spatial proportion of the warped frame than in the source frame;
encoding the warped frames to produce an encoded version of the video signal;
transmitting the encoded video signal to a receiving terminal over a packet-based network, as part of a live video call.

20. A computer program product for use in decoding the encoded video signal of claim 19, configured to apply post processing to reverse said spatial adaptation.
